(19) United States
(12) Patent Application Publication
(10) Pub. No.: US 2003/0201001 A1
(43) Pub. Date: Oct. 30, 2003

(54) Wet cleaning device

(76) Inventors: Hsin-Ta Chien, Taoyuan Hsien (TW); Hsuang-Sheng Tung, Tainan Hsien (TW); Ching-Yuan Chen, Hsinchu (TW)

Correspondence Address: BIRCH STEWART KOLASCH & BIRCH, PO BOX 747, FALLS CHURCH, VA, 22040-0747, US

(21) Appl. No.: 10/279,937

(22) Filed: Oct. 25, 2002

(30) Foreign Application Priority Data
Apr. 30, 2002 (TW) 91109019

(51) Int. Cl. B08B 3/00

(52) U.S. Cl. 134/61; 134/113; 134/157

(57) ABSTRACT

A wet cleaning device for chemically cleaning a plurality of wafers. The wet cleaning device includes a plurality of first chemical cleaning tanks for conducting a first cleaning procedure, a plurality of second chemical cleaning tanks for conducting a second cleaning procedure, a transferring tank including a first measuring device for measuring the wafers after the first cleaning procedure, a measuring tank including a second measuring device for measuring the wafers after the second cleaning procedure, a first transporting device, and a second transporting device.

### BACKGROUND OF THE INVENTION

1. Field of the Invention

The present invention relates to a wet cleaning device, and more particularly to a wet cleaning device that saves operating time and increases throughput.

2. Description of the Prior Art

Wet processing in semiconductor production includes wet chemical cleaning and wet etching. Wet chemical cleaning is particularly important. The purpose of chemical cleaning is to remove metal impurities, organic compounds, and particles, in order to increase the yield and reliability.

Presently, a common device for wet chemical cleaning is an immersion chemical cleaning device, also called wet bench, which includes a plurality of chemical tanks, cleaning tanks, robots, and dryers. The most commonly used chemical solutions in the chemical tank include a sulfuric-peroxide mixture (SPM), buffer oxide etcher (BOE), ammonium-peroxide mixture (APM), and hydrochloric-peroxide mixture (HPM). In addition, cleaning tanks generally include a quick dump rinse (QDR) tank, hot QDR (HQDR) tank, overflow (OF) tank, and final rinse (FR) tank.

FIG. 1 shows a block schematic diagram of a conventional wet cleaning device. RT1 and RT2 refer to robots (not shown), which transport a plurality of wafers (not shown) from first chemical cleaning tanks 11, to QDR/transferring tank 20, second chemical cleaning tanks 21, to FR/measuring tank 26, and finally drying tank 28. The first chemical cleaning tanks 11 include a plurality of first chemical cleaning tanks, for example, an SPM tank 10, HQDR tank 12, BOE tank 14, OF tank 16, and APM tank 18. The second chemical cleaning tanks 21 include a plurality of second chemical cleaning tanks, for example, an HPM tank 22 and QDR tank 24. In addition, a resistivity meter (not shown) is disposed in the FR/measuring tank 26 to measure the resistivity of the wafers. The wafers are dehydrated and dried in the drying tank 28.

FIG. 2 is a flow chart illustrating a cleaning process using the conventional wet cleaning device. First, wafers are loaded in the device by a robot RT1 (S20). Next, the wafers are placed in the first chemical cleaning tanks 11 by the robot RT1 to conduct a first cleaning procedure (S22). Next, whether a second cleaning procedure is needed is determined (S24). If the second cleaning procedure is needed, the robot RT2 removes the wafers from the transferring tank 20 and transports them to the second chemical cleaning tanks 21 to conduct a second cleaning procedure (S26). Next, the robot RT2 removes the wafers and transports them to the measuring tank 26 to measure the resistivity of the wafers (S28). Alternatively, if the second cleaning procedure is not needed, step 26 is not conducted and step 28 is conducted directly. Finally, the robot RT2 removes the wafers and transports them to the drying tank 28 (S30). However, since some recipes do not need the second cleaning procedure, the wafers must still wait in the transferring tank 20 until the robot RT2 transports them to the measuring tank 26. This wastes time and limits the robot RT1 from other procedures, thus decreasing production yield.

### SUMMARY OF THE INVENTION

The object of the present invention is to provide a wet cleaning device that saves operating time and increases throughput.

To achieve thebove-mentioned object, the wet cleaning device of the present invention includes a plurality of first chemical cleaning tanks for conducting a first cleaning procedure; a plurality of second chemical cleaning tanks; a transferring tank disposed between the first and second cleaning tanks and including a first measuring device for measuring the wafers after the first cleaning procedure is completed; a measuring tank including a second measuring device for measuring the wafers after the second cleaning procedure is completed; a first transporting device for loading, removing and transporting the wafers between the first chemical cleaning tanks and the transferring tank; and a second transporting device for loading, removing and transporting the wafers to the transferring tank, the second chemical cleaning tanks, and the measuring tank. The first and second measuring devices can be resistivity meters to measure the resistivity of the wafers. In addition, the first and second transporting devices can be robots.

The present invention also provides a cleaning process using a wet cleaning device. The process includes the following steps. First, a wet cleaning device is provided. The wet cleaning device includes a plurality of first chemical cleaning tanks; a plurality of second chemical cleaning tanks; a transferring tank including a first measuring device; a measuring tank including a second measuring device; a first transporting device; a second transporting device; and a drying tank. Next, wafers are loaded in the first chemical cleaning tanks by the first transporting device to conduct a first cleaning procedure. Next, the wafers are transported from the first chemical cleaning tanks to the transferring tank by the first transporting device and it is determined whether a second cleaning procedure is needed. If the second cleaning procedure is not needed, wafers are measured in the transferring tank. If the second cleaning procedure is needed, the wafers are transported from the transferring tank to the second chemical cleaning tanks by the second transporting device to conduct a second cleaning procedure. Next, the wafers are transported from the second chemical cleaning tanks to the measuring tank by the second transporting device to be measured. Finally, after the wafers are measured, wafers are transported by the second transporting device to the drying tank to be dried. The first and second measuring devices can be resistivity meters to measure the resistivity of the wafers. In addition, the first and second transporting devices can be robots.

In the wet cleaning device of the present invention, the transferring tank includes a measuring device for measuring the wafers. If the wafers do not need the second cleaning procedure, the wafers are directly measured for resistivity in the transferring tank. Therefore, the operating time of wafers in the wet cleaning device is decreased. In addition, if the wafers are measured in the transferring tank, the transporting devices can perform other operations, increasing flexibility and throughput.

### BRIEF DESCRIPTION OF THE DRAWINGS

The present invention will become more fully understood from the detailed description given hereinbelow and theccompanying drawings, given by way of illustration only and thus not intended to be limitative of the present invention.

FIG. 1 shows a block schematic diagram of a conventional wet cleaning device.

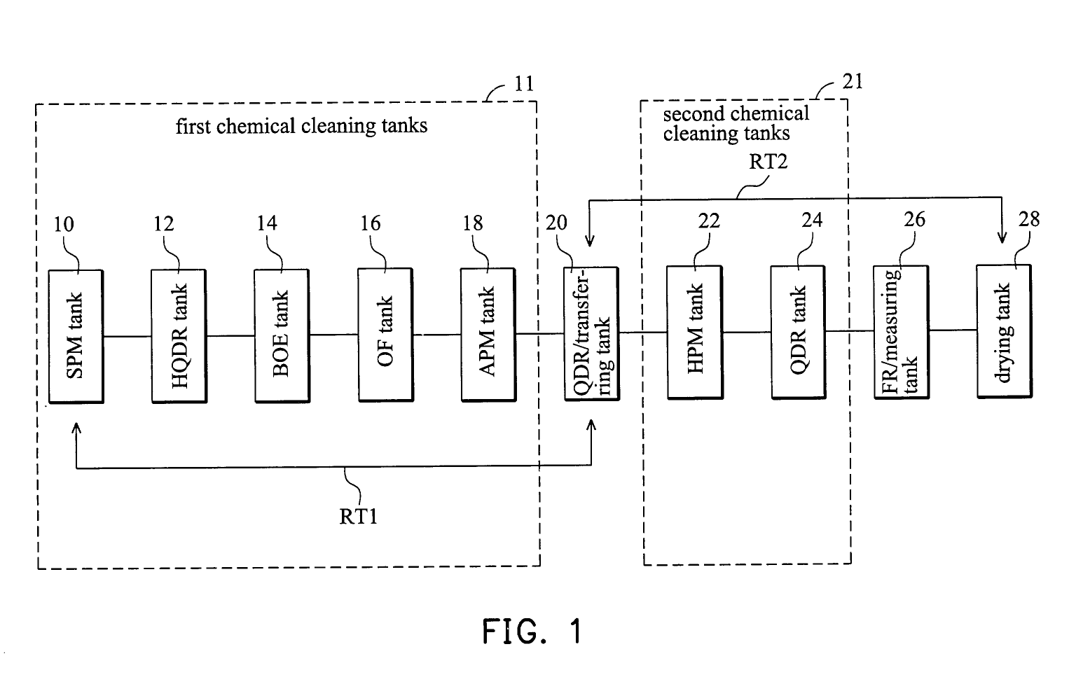

FIG. 2 is a flow chart illustrating a cleaning process using a conventional wet cleaning device.

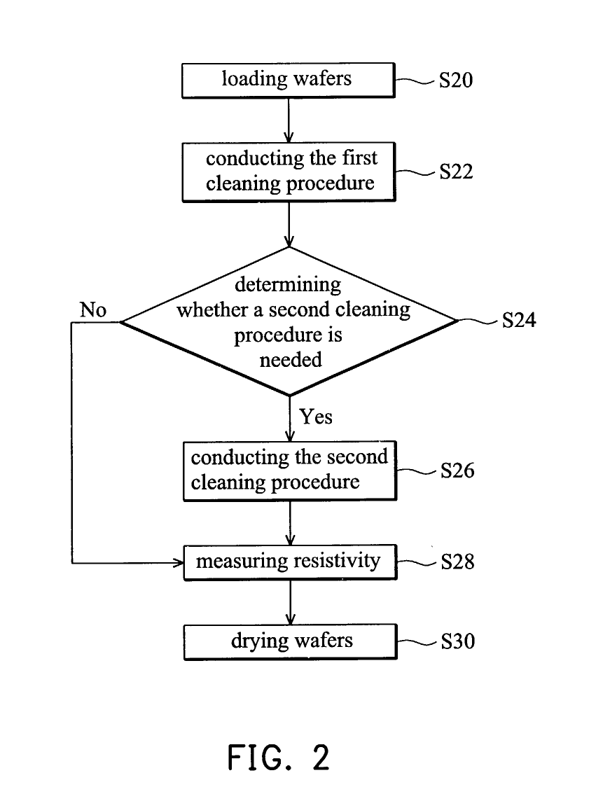

FIG. 3 shows a block schematic diagram of a wet cleaning device according to an embodiment of the present invention.

FIG. 4 is a flow chart illustrating a cleaning process using the wet cleaning device of the embodiment of the present invention.

### DETAILED DESCRIPTION OF THE INVENTION

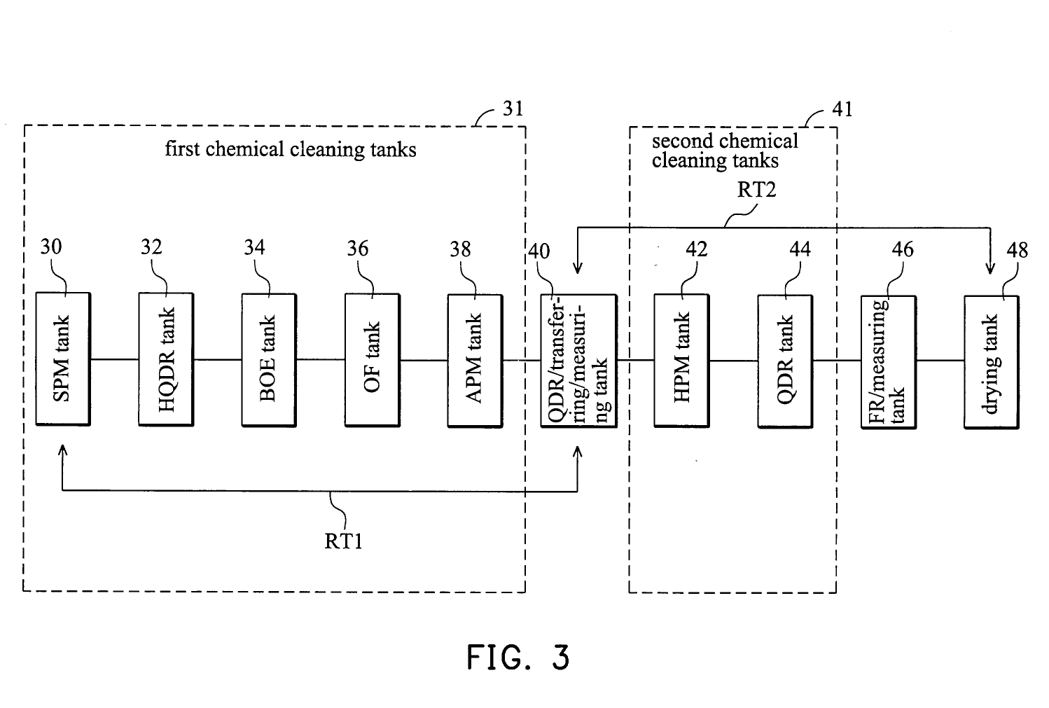

FIG. 3 shows a block schematic diagram of a wet cleaning device according to an embodiment of the present invention. The wet cleaning device includes a plurality of first chemical cleaning tanks 31, a plurality of second chemical cleaning tanks 41, a transferring tank 40, a measuring tank 46, a first transporting device RT1, a second transporting device RT2, and a drying tank 48.

The first chemical cleaning tanks 31 conduct a first cleaning procedure on wafers (not shown) and include at least one first chemical tank and at least one first cleaning tank. The first chemical tank includes a chemical solution which can be a sulfuric-peroxide mixture (SPM), a buffer oxide etcher (BOE), or an ammonium-peroxide mixture (APM). The first cleaning tank can be a hot quick dump rinse (HQDR) tank, an overflow (OF) tank, or a quick dump rinse (QDR) tank. For example, in FIG. 3, the first chemical cleaning tanks 31 include an SPM tank 30, HQDR tank 32, BOE tank 34, OF tank 36 and APM tank 38.

The second chemical cleaning tanks 41 conduct a second cleaning procedure and include at least one second chemical tank and at least one second cleaning tank. The second chemical tank includes a chemical solution and the chemical solution can be a hydrochloric-peroxide mixture (HPM). The second cleaning tank can be a quick dump rinse (QDR) tank. For example, in FIG. 3, the second chemical cleaning tanks 41 include an HPM tank and QDR tank 44.

The transferring tank 40 is disposed between the first and second cleaning tanks 31 and 41 and includes a first measuring device (not shown) for measuring the wafers after the first cleaning procedure is completed. The first measuring device can be a resistivity meter to measure the resistivity of the wafers. Moreover, the transferring tank 40 can be a quick dump rinse tank. Therefore, the transferring tank 40 can perform transfer, measurement, and quick dump rinsing. For example, in FIG. 3, the transferring tank 40 can be a QDR/transferring/measuring tank.

The measuring tank 46 includes a second measuring device (not shown) for measuring the wafers after the second cleaning procedure is completed. The measuring tank 46 can also be a final rinse (FR) tank. For example, in FIG. 3, the measuring tank 46 can be a FR/measuring tank. The second measuring device can be a resistivity meter to measure the resistivity of the wafers.

The first transporting device RT1 (not shown) (such as a robot) loads, removes and transports the wafers between the first chemical cleaning tanks 31 and the transferring tank 40. The second transporting device RT2 (not shown) (such as a robot) loads, removes and transports the wafers to the transferring tank 40, the second chemical cleaning tanks 41, and the measuring tank 46.

After measurement, the drying tank 48 dries the wafers preferably by spin drying or Marangoni drying.

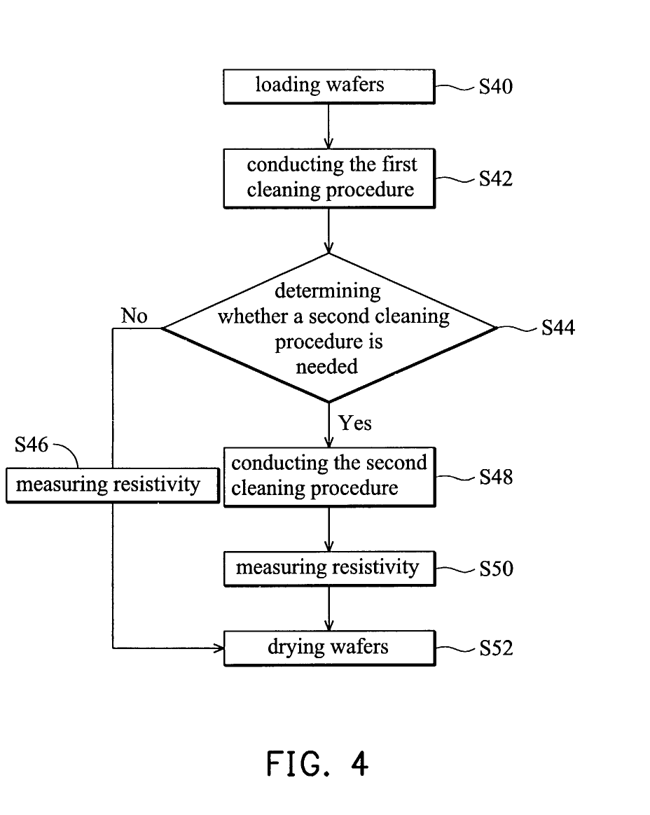

FIG. 4 is a flowchart illustrating a cleaning process using the wet cleaning device of the embodiment of the present invention. First, wafers are loaded in the wet cleaning device by the robot RT1 (S40). Next, the wafers are placed in the first chemical cleaning tanks 31 by the robot RT1 to conduct a first cleaning procedure (S42). Next, the wafers are removed from the first chemical cleaning tanks 31 and transported to the transferring tank 40 by the robot RT1. It is determined whether a second cleaning procedure is needed (S44). If so, the robot RT2 removes the wafers from the transferring tank 40 and transports them to the second chemical cleaning tanks 41 to conduct a second cleaning procedure (S48). Next, robot RT2 removes the wafers and transports them to the measuring tank 46 for measuring the resistivity of the wafers by a resistivity meter (S50). Finally, the robot RT2 removes the wafers and transports them to the drying tank 48 to dry the wafers by spin drying or Marangoni drying (S52). Alternatively, if the second cleaning procedure is not needed, step S48 is not conducted. After step S44, the wafers are measured by a resistivity meter disposed in the transferring tank 40 (S46). The robot RT2 removes the wafers and transports them to the drying tank 48 (S52).

Generally, a wet cleaning device undergoes different cleaning recipes to clean wafers simultaneously. Some recipes conduct the first and second cleaning procedures, but some only the first cleaning procedure and not the second cleaning procedure. According to the present invention, if the wafers do not need the second cleaning procedure, they are directly measured for resistivity in the transferring tank 40 and need not be transported to the measuring tank 46 by the robot RT2. Therefore, the operating time of wafers in the wet cleaning device is decreased. In addition, since the wafer measuring time is longer than transfer time, if the wafers are measured in the transferring tank 40, the robots RT1 and RT2 can perform other operations. Thus, the wet cleaning device of the present invention has improved throughput compared to the conventional wet cleaning device.

The foregoing description of the preferred embodiments of this invention has been presented for purposes of illustration and description. Obvious modifications or variations are possible in light of thebove teaching. The embodiments were chosen and described to provide the best illustration of the principles of this invention and its practical application to thereby enable those skilled in thert to utilize the invention in various embodiments and with various modifications as are suited to the particular use contemplated. All such modifications and variations are within the scope of the present invention as determined by theppended claims when interpreted in accordance with the breadth to which they are fairly, legally, and equitably entitled.

What is claimed is:

1. A wet cleaning device suitable for chemically cleaning a plurality of wafers, comprising:
a plurality of first chemical cleaning tanks for conducting a first cleaning procedure on the wafers;
a plurality of second chemical cleaning tanks for conducting a second cleaning procedure on the wafers;
a transferring tank disposed between the first and second cleaning tanks and including a first measuring device for measuring the wafers after the first cleaning procedure is completed;
a measuring tank including a second measuring device for measuring the wafers after the second cleaning procedure is completed;
a first transporting device for loading, removing and transporting the wafers between the first chemical cleaning tanks and the transferring tank; and
a second transporting device for loading, removing and transporting the wafers to the transferring tank, the second chemical cleaning tanks, and the measuring tank.

2. The wet cleaning device as claimed in claim 1, further comprising a drying tank for drying the wafers after measurement.

3. The wet cleaning device as claimed in claim 1, wherein the first chemical cleaning tanks include at least one first chemical tank and at least one first cleaning tank.

4. The wet cleaning device as claimed in claim 1, wherein the second chemical cleaning tanks include at least one second chemical tank and at least one second cleaning tank.

5. The wet cleaning device as claimed in claim 1, wherein the first and second measuring devices are resistivity meters to measure the resistivity of the wafers.

6. The wet cleaning device as claimed in claim 1, wherein the transferring tank is a quick dump rinse tank.

7. The wet cleaning device as claimed in claim 1, wherein the first and second transporting devices are robots.

8. The wet cleaning device as claimed in claim 2, wherein the drying tank dries the wafers by spin drying or Marangoni drying.

9. The wet cleaning device as claimed in claim 3, wherein the first chemical tank includes a chemical solution and the chemical solution is a sulfuric-peroxide mixture, a buffer oxide etcher, or an ammonium-peroxide mixture.

10. The wet cleaning device as claimed in claim 3, wherein the first cleaning tank is a hot quick dump rinse tank, an overflow tank, or a quick dump rinse tank.

11. The wet cleaning device as claimed in claim 4, wherein the second chemical tank includes a chemical solution and the chemical solution is a hydrochloric-peroxide mixture.

12. The wet cleaning device as claimed in claim 4, wherein the second cleaning tank is a quick dump rinse tank.
